(19) United States
(12) Patent Application Publication
(10) Pub. No.: US 2015/0023548 A1
(43) Pub. Date: Jan. 22, 2015

(54) INFORMATION PROCESSING DEVICE AND PROGRAM

(71) Applicant: TOSHIBA TEC KABUSHIKI KAISHA, Tokyo (JP)

(72) Inventor: Masatsugu FUKUDA, Kannami Shizuoka (JP)

(21) Appl. No.: 14/332,238

(22) Filed: Jul. 15, 2014

(30) Foreign Application Priority Data
Jul. 16, 2013 (JP) 2013-147934
Apr. 11, 2014 (JP) 2014-082272

(51) Int. Cl. G06K 9/62; G06Q 30/06; G06K 9/46

(52) U.S. Cl. CPC G06K 9/6202; G06K 9/4652; G06Q 30/0643
USPC 382/100

(57) ABSTRACT

An information processing device includes an image taking section having a connection to an image capturing device by which the image taking section instructs the image capturing device to capture an image of a merchandise, a processor configured to recognize candidates based on the captured image of the merchandise, and a display controller configured to display the candidates and highlight a group of the candidates that are related.

### CROSS-REFERENCE TO RELATED APPLICATION

This application is based upon and claims the benefit of priority from Japanese Patent Application No. 2013-147934, filed Jul. 16, 2013 and Japanese Patent Application No. 2014-082272, filed Apr. 11, 2014; the entire contents of both applications are incorporated herein by reference.

### FIELD

Embodiments described herein relate generally to an information processing device and a program.

### BACKGROUND

In the related art, technology employed to recognize a commodity according to its type, or the like, by extracting feature data of the commodity from image data which is obtained by capturing an image of the commodity, and comparing the feature data with reference feature data prepared in advance. In addition, a store system in which a sales registration of recognized merchandise is performed using the technology for merchandise such as a fruit and vegetable, has been proposed. In the store system, when there are a plurality of candidate merchandise, the candidates are displayed so as to be selected by a user.

However, in the above-described store system of the related art, a display method of the candidates is not taken into consideration at all, and it merely lists the plurality of candidates. For this reason, even when there are candidates which are related to each other in the plurality of candidates, for example, there is a possibility that a user may not recognize any relationship among them.

### DESCRIPTION OF THE DRAWINGS

FIG. 1 is a perspective view which illustrates an external configuration of a checkout system according to an embodiment.

FIG. 2 is a block diagram which illustrates a hardware configuration of a POS terminal and a merchandise reading device which are illustrated in FIG. 1.

FIG. 3 is a diagram which schematically illustrates an example of a data structure of a PLU file which is illustrated in FIG. 2.

FIG. 4 is a diagram which schematically illustrates an example of a data structure of a group setting file which is illustrated in FIG. 2.

FIG. 5 is a block diagram which illustrates a functional configuration of the POS terminal and the merchandise reading device which are illustrated in FIG. 1.

FIG. 6 is a diagram which illustrates a display example of a candidate screen.

FIG. 7 is a diagram which illustrates another display example of the candidate screen.

FIG. 8 is a diagram which illustrates still another display example of the candidate screen.

FIG. 9 is a flowchart which illustrates a procedure of merchandise recognition processing which is executed by the merchandise reading device.

FIG. 10 is a flowchart which illustrates a procedure of a sales registering process which is executed by the POS terminal.

FIG. 11 is a perspective view which illustrates an external configuration of a self checkout system according to an embodiment.

FIG. 12 is a block diagram which illustrates a hardware configuration of the self checkout system which is illustrated in FIG. 11.

### DETAILED DESCRIPTION

In general, according to one embodiment, there is provided an information processing device which includes an image taking section, a processor, and a display controller. The image taking section has a connection to an image capturing section by which the image taking section instructs the image capturing device to capture an image of a merchandise. The processor is configured to recognize candidates based on the captured image of the merchandise. The display controller is configured to display the candidates and highlight a group of candidates that are related.

Hereinafter, the information processing device and the program according to the embodiment will be described with reference to the drawings.

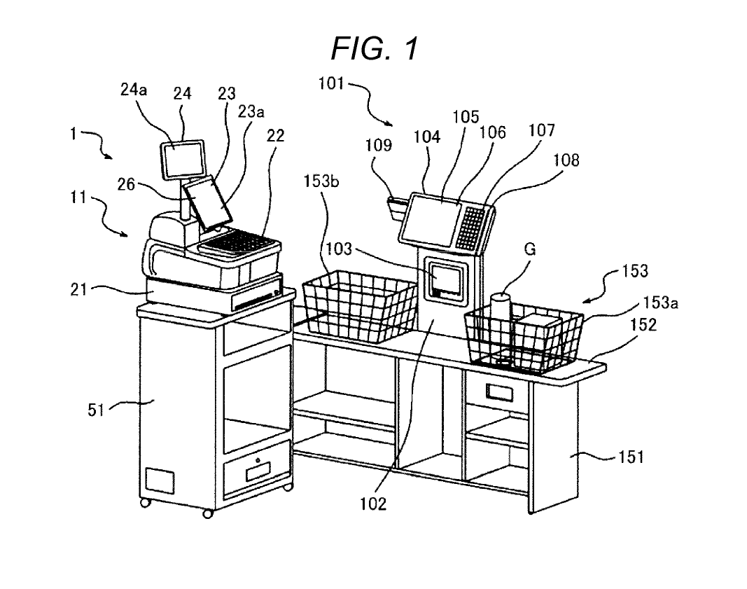

FIG. 1 is a perspective view which illustrates an external configuration of a checkout system 1. As illustrated in FIG. 1, the checkout system 1 includes a POS terminal 11, and a merchandise reading device 101 as the information processing device.

The POS terminal 11 is placed on a top face of a drawer 21 on a checkout stand 51. The drawer 21 is under a control of the POS terminal 11 in an opening operation thereof. A keyboard 22 which is subject to a pressing operation by an operator (sales person, or the like) is arranged on a top face of the POS terminal 11. A display unit 23 which displays information toward the operator is provided in a deeper place than the keyboard 22 when viewed from the operator who operates the keyboard 22. The display unit 23 displays information on a display face 23a thereof. A touch panel 26 is laminated on the display face 23a. A display unit for customer is rotatable and arranged in a deeper place than the display unit 23. The display unit for customer 24 displays information on a display face 24a thereof.

In addition, the display unit for customer 24 which is illustrated in FIG. 1 is in a state of causing the display face 24a to face a near side in FIG. 1, however, the display unit for customer 24 displays information toward a customer by rotating so that the display face 24a faces the back side in FIG. 1.

An oblong table-shaped counter stand 151 is arranged so as to form an L shape with respect to the checkout stand 51 on which the POS terminal 11 is placed. A goods receiving face 152 is formed on a top face of the counter stand 151. A shopping basket 153 which accommodates merchandise G is placed on the goods receiving face 152. The shopping basket 153 may be divided into a first shopping basket 153a which is brought in by a customer, and a second shopping basket 153b which is placed at a position to interpose the merchandise reading device 101 between the first shopping basket 153a and the second shopping basket 153b.

The merchandise reading device 101 which is connected to the POS terminal 11 so as to perform data transceiving is provided on the goods receiving face 152 of the counter stand 151. The merchandise reading device 101 includes a housing 102 which is in a thin rectangle shape.

A reading window 103 is arranged on a front face of the housing 102. A display and operation unit 104 is attached to the upper portion of the housing 102. A display unit 106 such as a liquid crystal display on which a touch panel 105 is laminated on the front surface thereof is provided in the display and operation unit 104. A keyboard 107 is arranged at a position to the right of the display unit 106. A card reading groove 108 of a card reader (not illustrated) is provided at a position to the right of the keyboard 107. A display unit for customer 109 for providing information to a customer is provided at a deep place on the left on the rear face of the display and operation unit 104 when viewed from the operator side.

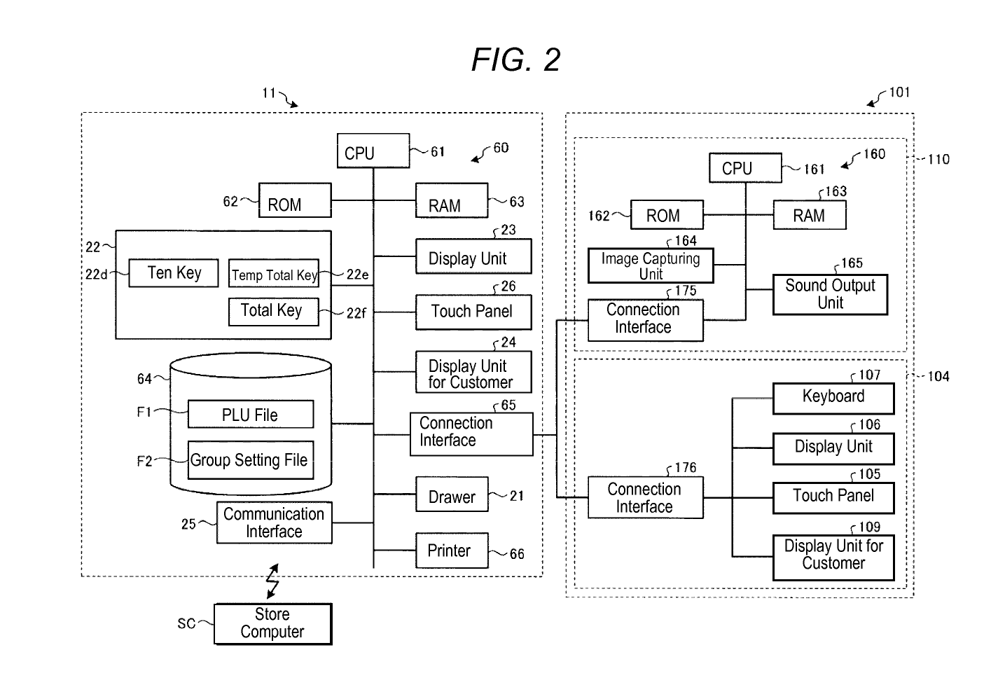

Merchandise G of one transaction is accommodated in the first shopping basket 153a which is brought in by a customer. The merchandise G in the first shopping basket 153a is moved to the second shopping basket 153b by an operator who operates the merchandise reading device 101. The merchandise G is caused to face the reading window 103 of the merchandise reading device 101 in the moving process. At this time, a capturing unit 164 (refer to FIG. 2) which is arranged in the reading window 103 captures an image of the merchandise G.

FIG. 2 is a block diagram which illustrates hardware configurations of the POS terminal 11 and the merchandise reading device 101.

The POS terminal 11 includes a microcomputer 60 which is an information processing unit which executes information processing. The microcomputer 60 includes a Central Processing Unit (CPU) 61 which controls each unit by executing various arithmetic processing, a Read Only Memory (ROM) 62, and a Random Access Memory (RAM) 63. The ROM 62 stores a program which is executed by the CPU 61.

All of the drawer 21, the keyboard 22, the display unit 23, the display unit for customer 24, a communication interface 25, the touch panel 26, a hard disk drive (HDD) 64, a connection interface 65, and a printer 66 are connected to the CPU 61 of the POS terminal 11 through various input-output circuits (all are not illustrated).

The keyboard 22 includes a ten key 22d on which figures such as “1”, “2”, “3”, . . . , or an operator of multiplication “x” are displayed on a top face thereof, a temporary total key 22e, and a total key 22f.

The HDD 64 stores various programs and files. The CPU 61 copies all or a portion of a program which is stored in the HDD 64 into the RAM 63, and executes the program when starting the POS terminal 11, or the like.

In addition, the HDD 64 stores a data file such as a PLU file F1, and a group setting file F2. The PLU file F1 and the group setting file F2 may be read from the merchandise reading device 101 through the connection interface 65.

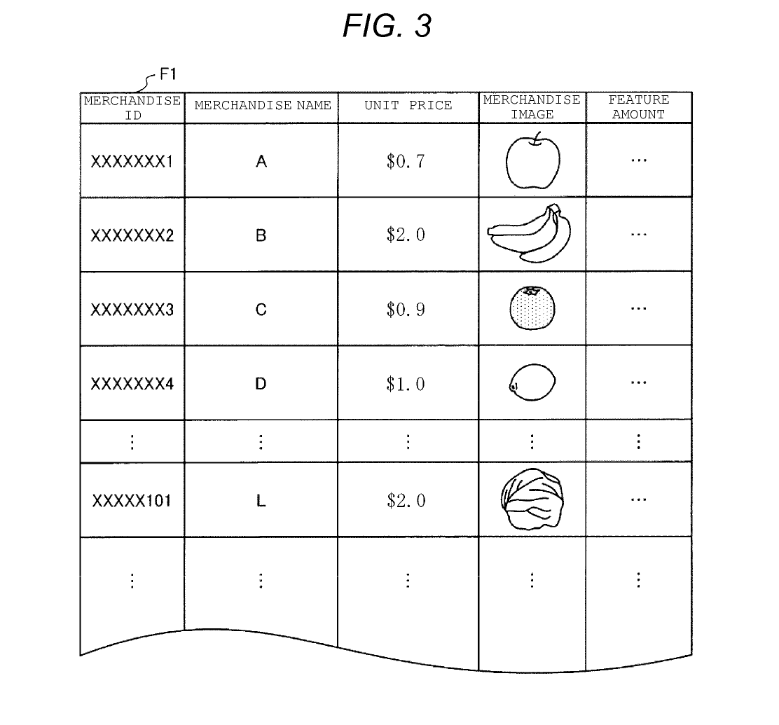

The PLU file F1 is a data file in which association of merchandise G which is sold in a store with information related to sales registering, or the like, of the merchandise G is set. FIG. 3 is a diagram which schematically illustrates an example of a data structure of the PLU file F1. As illustrated in FIG. 3, information related to merchandise such as a merchandise ID which is uniquely assigned, a merchandise name, and a unit price, and a merchandise image which is obtained by capturing an image of the merchandise G are registered by being associated with each other in each merchandise G, in the PLU file F1. In addition, feature data of the merchandise for each merchandise G is registered in the PLU file F1 by being associated in advance.

The merchandise image is an image of each reference merchandise which is captured, as a comparison target when making a similarity determination which will be described later. The merchandise image is presented as an image which denotes a merchandise candidate which will be described later. In addition, feature data of the merchandise G which is extracted in advance from a captured image of each merchandise G (for example, merchandise image) is registered in association with a merchandise ID corresponding thereto. Here, the feature data is information denoting features of the merchandise G such as a hue or pattern, irregularity on the front surface, and a shape of the merchandise G.

In addition, according to the embodiment, feature data of each merchandise G is registered in the PLU file F1 in advance, however, it is not limited to this, and the feature data may not be registered. In this case, feature data maybe obtained on each occasion by extracting feature data from each merchandise image using a feature data extracting unit 1613 which will be described later. In addition, an image for presentation may be registered instead of the merchandise image. Hereinafter, merchandise which is registered in the PLU file F1 will be referred to as “registered merchandise”.

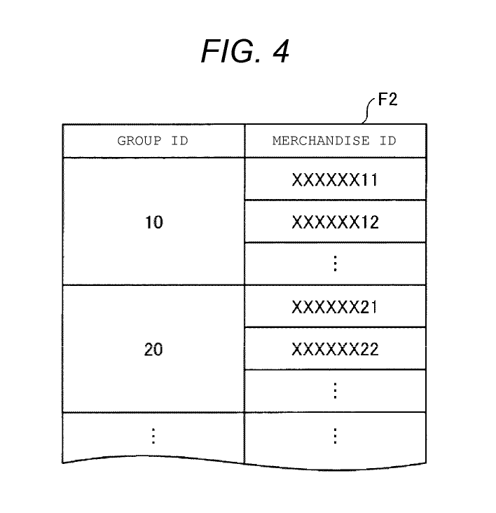

The group setting file F2 is a data file (set information) for managing registered merchandise which has predetermined relevance as merchandise which belongs to the same group. FIG. 4 is a diagram which schematically illustrates an example of a data structure of the group setting file F2. As illustrated in FIG. 4, a group ID which is uniquely assigned in each group, and a merchandise ID of registered merchandise which belongs to the group are registered in association with each other in the group setting file F2.

In addition, a combination of registered merchandise which is set to a group is of no particular importance. For example, when there are a plurality of sales forms with respect to the same merchandise, a merchandise ID which is assigned to each sales form may be included in the same group. In this case, for example, the same merchandise which is sold in one unit, or in a state of being cut into ½, or ¼ maybe caused to belong to the same group. In addition, a merchandise ID of registered merchandise which belongs to the same category or type may be caused to belong to the same group. In this case, for example, it is possible to cause each type which is categorized into “apple” of a name of type to belong to the same group. In addition, even in a case of registered merchandise which is different from each other, registered merchandise with similar characteristic in appearance may be caused to belong to the same group. In this case, for example, it is possible to cause registered merchandise in which misrecognition may occur when recognizing a merchandise candidate which will be described later, to belong to the same group.

Returning to FIG. 2, the communication interface 25 for executing a data communication with a store computer SC is connected to the CPU 61 of the POS terminal 11 through an input-output circuit (not illustrated). The store computer SC is installed in a back office, or the like, of a store. An HDD (not illustrated) of the store computer SC stores the PLU file F1 which is delivered to the POS terminal 11, the group setting file F2, a stock management file for managing an inventory situation of each registered merchandise which is registered in the PLU file F1, or the like.

The connection interface 65 is capable of performing data transceiving with the merchandise reading device 101. The merchandise reading device 101 is connected to the connection interface 65. In addition, the printer 66 performs printing on a receipt, or the like. The POS terminal 11 prints transaction contents of one transaction on a receipt in the printer 66 under a control of the CPU 61.

The merchandise reading device 101 includes a merchandise reading unit 110 and the display and operation unit 104. The merchandise reading unit 110 includes a microcomputer 160. The microcomputer 160 includes a CPU 161, a ROM 162, and a RAM 163. The ROM 162 stores a program which is executed by the CPU 161.

An image capturing unit 164, a sound output unit 165, and a connection interface 175 are connected to the CPU 161 through various input-output circuits (none are illustrated). Operations of the image capturing unit 164, the sound output unit 165, and the connection interface 175 are controlled by the CPU 161.

The image capturing unit 164 is a color CCD sensor, a color CMOS sensor, or the like, and is a capturing section which performs capturing from the reading window 103. For example, in the image capturing unit 164, capturing of a moving image of a frame rate of 30 fps is performed. A frame image (captured image) which is sequentially captured by the image capturing unit 164 at a predetermined frame rate is stored in the RAM 163. The sound output unit 165 is a sound circuit, a speaker, or the like, for generating an alarm sound, or the like, which is preset. The sound output unit 165 performs a notification function using sound such as the alarm sound, or the like, under a control of the CPU 161.

The display and operation unit 104 includes the touch panel 105, the display unit 106, the keyboard 107, the display unit for customer 109, and a connection interface 176. The connection interface 175 of the merchandise reading unit 110 is connected to the connection interface 65 of the POS terminal 11, and may perform data transceiving with the POS terminal 11. The connection interface 175 is connected to the display and operation unit 104 through the connection interface 176, and the CPU 161 performs data transceiving between the merchandise reading unit 110 and the display and operation unit 104 through the connection interface 175.

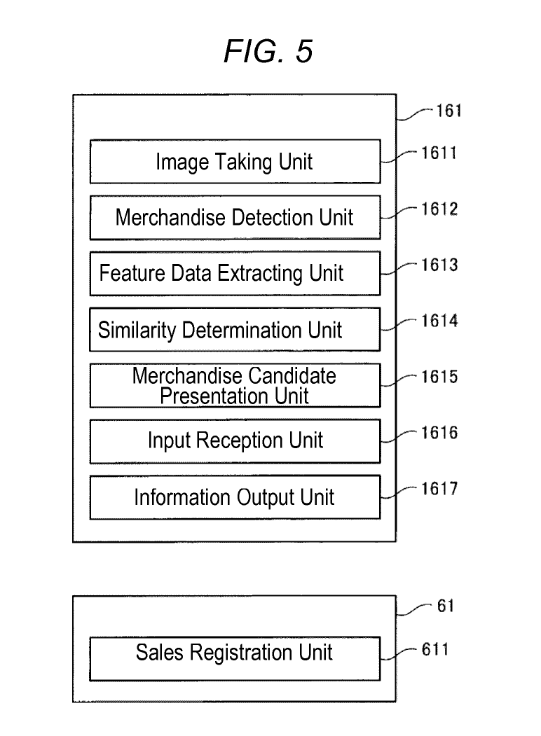

Subsequently, functional configurations of the POS terminal 11 and the merchandise reading device 101 which are attained when the CPUs 161 and 61 execute programs will be described with reference to FIG. 5.

FIG. 5 is a block diagram which illustrates functional configurations of the POS terminal 11 and the merchandise reading device 101. As illustrated in FIG. 5, the CPU 161 of the merchandise reading device 101 is configured through a sequence of program instructions to provide functions of an image taking unit 1611, a merchandise detection unit 1612, a feature data extracting unit 1613, a similarity determination unit 1614, a merchandise candidate presentation unit 1615, an input reception unit 1616, and an information output unit 1617.

The image taking unit 1611 is a functional unit which functions as an image taking section. The image taking unit 1611 outputs an image capture ON signal to the image capturing unit 164, and causes the image capturing unit 164 to start an image capturing operation. The image taking unit 1611 subsequently takes the captured images which are captured by the image capturing unit 164 after starting the image capturing operation, and stores them in the RAM 163. The taking of the captured image using the image taking unit 1611 is performed according to an order stored in the RAM 163.

The merchandise detection unit 1612 detects all or a portion of contours of the merchandise G which is included in the captured image which is taken by the image taking unit 1611 using a known pattern matching technology, or the like. Subsequently, a contour which is extracted from the previous captured image (frame image) is compared to a contour which is extracted from a frame image this time, and a portion at which there is a change, that is, an image captured region of the merchandise G which was caused to face the reading window 103, is detected.

As another method of detecting the merchandise G, there is a method which includes determining whether or not a flesh-colored region is detected from the captured image. When the flesh-colored region is detected, that is, when a hand of a sales person is detected, extracting a contour of the merchandise G which is assumed to be gripped by the hand of the sales person is attempted by detecting the above described contour in the vicinity of the flesh-colored region. At this time, when a contour denoting a shape of the hand, and a contour of an object other than the contour of the hand are detected in the vicinity thereof, the merchandise G is detected from the contour of the object.

The feature data extracting unit 1613 extracts a state on the front surface of the merchandise G (hue, pattern, irregularity on the front surface, shape, and the like) which is detected in the merchandise detection unit 1612 from the captured image which is taken by the image taking unit 1611 as feature data.

The similarity determination unit 1614 is a functional unit which functions as a recognition section. The similarity determination unit 1614 compares feature data of each registered merchandise which is registered in the PLU file F1 to feature data which is extracted in the feature data extracting unit 1613, and calculates a similarity thereof, respectively. In addition, the similarity determination unit 1614 recognizes registered merchandise (merchandise ID) of which a value is equal to or greater than a predetermined threshold value, among the calculated similarities, as a candidate of the merchandise G which is captured in the image capturing unit 164. In addition, the similarity determination unit 1614 specifies the recognized candidates and registered merchandise which belongs to a group of merchandise which is set using predetermined relevance from the group setting file F2, and recognizes the registered merchandise as a candidate also.

Here, the similarity may be a value (similarity) which denotes how much both feature amounts are similar when comparing feature data of merchandise G and a reference feature amount of merchandise which is registered in the PLU file F1 with each other. In addition, a concept of the similarity is not limited to this, and may be a value which denotes conformity to feature data of each registered merchandise which is registered in the PLU file F1, or a value which denotes how much feature data of the merchandise G is related to the feature data of each registered merchandise which is registered in the PLU file F1.

Recognizing an object included in an image as described above is referred to as generic object recognition. With respect to such generic object recognition, various recognition technologies are explained in the following document.

Keiji Yanai, “Current State and Future Directions on Generic Object Recognition” Journal of Information Processing Society of Vol. 48, No. SIG16 [search on Jan. 24, 2013], Internet <URL:http://mm.cs.uec.ac.jp/IPSJ-TCVIM-Yanai.pdf>

In addition, a technology of performing the generic object recognition by performing a region division of an image for each object is explained in the following document.

Jamie Shotton, et al., “Semantic Texton Forests for Image Categorization and Segmentation” [search on Jan. 24, 2013], Internet <URL:http://citeseerx.ist.psu.edu/viewdoc/download?doi=10. 1.1.145.3036&rep=rep1&type=pdf>

In addition, a calculation method of similarity is of no particular importance. For example, similarity may be calculated as an absolute evaluation, or may be calculated as a relative evaluation. When similarity is calculated as the absolute evaluation, an image of captured merchandise G and registered merchandise are compared one to one, and similarity which is derived as a result of the comparison may be adopted as is. In addition, when similarity is calculated as the relative evaluation, a total sum of similarity of the captured merchandise G and each registered merchandise may be calculated to be 1.0 (100%).

The candidate presentation unit 1615 is a functional unit which corresponds to a display control section. The candidate presentation unit 1615 displays information on the registered merchandise which is recognized as a candidate in the similarity determination unit 1614 on the display unit 106. More specifically, the candidate presentation unit 1615 reads a record of the registered merchandise which is recognized as the candidates for merchandise from the PLU file F1 of the POS terminal 11, and displays the record in a screen of the candidates for merchandise of the display unit 106. In addition, the candidate presentation unit 1615 specifies a group of candidates which belongs to the same group among recognized candidates based on the group setting file F2. In addition, the candidate presentation unit 1615 displays the specified group of candidates for merchandise by highlighting the group in a distinguishable state.

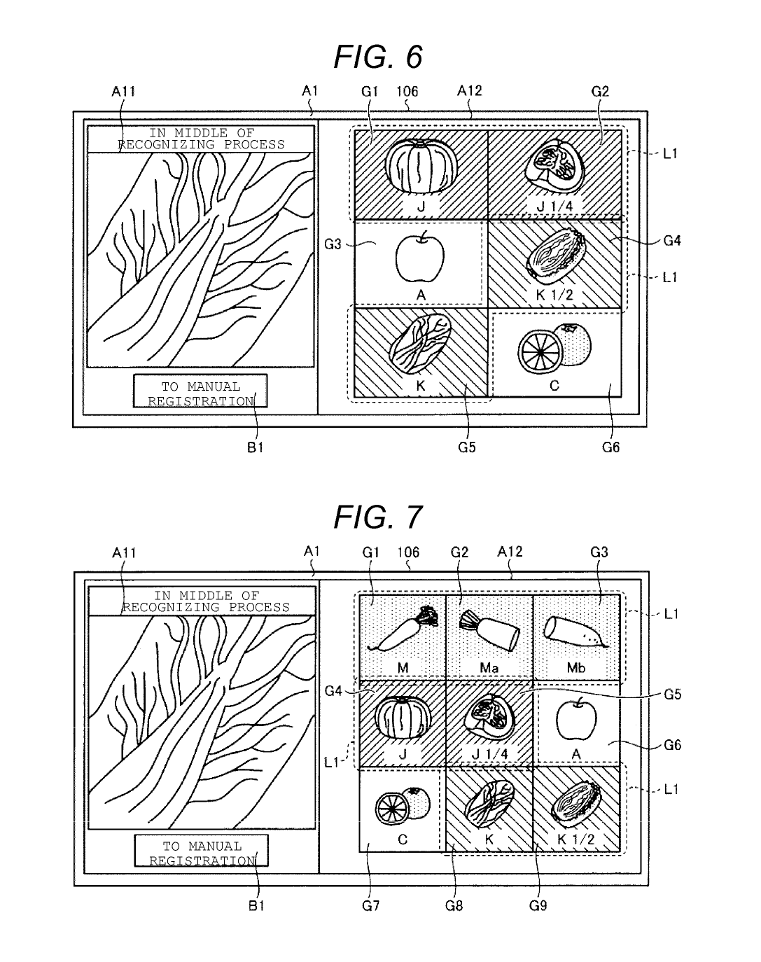

FIG. 6 is a diagram which illustrates a display example of a candidate screen. As illustrated in FIG. 6, a candidate screen A1 of the display unit 106 includes a captured image region A11 and a presentation region A12 for the candidates.

The captured image region A11 is a region for displaying a captured image which is taken by the image taking unit 1611. The presentation region A12 is a region for displaying merchandise image, or the like, of each registered merchandise which is recognized as a candidate. Merchandise images (G1 to G6) of the candidates which are recognized in the similarity determination unit 1614 are displayed along with merchandise names in the presentation region A12. In addition, the merchandise name may be displayed in the presentation region A12 without displaying the merchandise image of the candidate which is recognized in the similarity determination unit 1614.

In addition, a manual registration button B1 for selecting (registering) a merchandise manually from a sector code, a merchandise list, or the like, is provided on the lower portion of the captured image region A11. The CPU 161 displays a manual registration screen (not illustrated) for manually performing a registration of merchandise on the display unit 106 according to the operation of the manual registration button B1. In addition, merchandise which is registered through the manual registration screen is processed as decided merchandise which will be described later.

The candidate presentation unit 1615 displays the merchandise image of the candidate or the merchandise name which is recognized in the similarity determination unit 1614 in the presentation region A12. Here, for example, it is assumed that the candidates corresponding to merchandise images G1 and G2 belong to the same group, and the candidates corresponding to merchandise images G4 and G5 belong to another same group. In this case, as illustrated in FIG. 6, the candidate presentation unit 1615 displays a background color of the merchandise images G1 and G2 to be different from that in another merchandise image. In addition, the candidate presentation unit 1615 displays a background color of the merchandise images G4 and G5 to be different from that in another merchandise image. For example, a background color of G1 and G2 is set to a red color, a background color of G3 and G4 is set to a blue color, and a background color of a merchandise image which does not belong to a group is set to a white color. It is possible to arbitrarily set a background color of a merchandise image of a candidate.

In this manner, the candidate presentation unit 1615 displays a candidate which belong to the same group among candidates which are recognized in the similarity determination unit 1614 by highlighting the candidate through color classification. In this manner, since an operator may easily recognize a candidate which has predetermined relevance, it is possible to improve usability of a display of candidate merchandise, or a selection of candidate merchandise.

In addition, the arranging order of the candidates in the presentation region A12 is of no particular importance. For example, it may be an arrangement in which candidates with high similarity are put in order. In addition, it may be a form in which candidates which belong to the same group are arranged side by side. Here, “arranging side by side” is based on an arrangement rule in the presentation region A12. For example, when the arrangement rule is determined to be an arrangement from the left end of the upper section to the right end of the upper section→from the left end of the middle section to the right end of the middle section→from the right end of the lower section to the left end of the lower section, a candidate in the same group is arranged at an arranging position which is continuous in this arranging order.

In addition, a display form of the presentation region A12 is not limited to an arrangement layout of three rows and two columns which is illustrated in FIG. 6. For example, as illustrated in FIG. 7, a display may be possible in which an arrangement layout of three rows and three columns is used. Here, FIG. 7 is a diagram which illustrates another display example of a candidate screen. In FIG. 7, a display example in which backgrounds of merchandise images (G1 to G9) of nine candidates which are recognized in the similarity determination unit 1614 are subjected to a color classification according to a group to which the candidate belongs is illustrated.

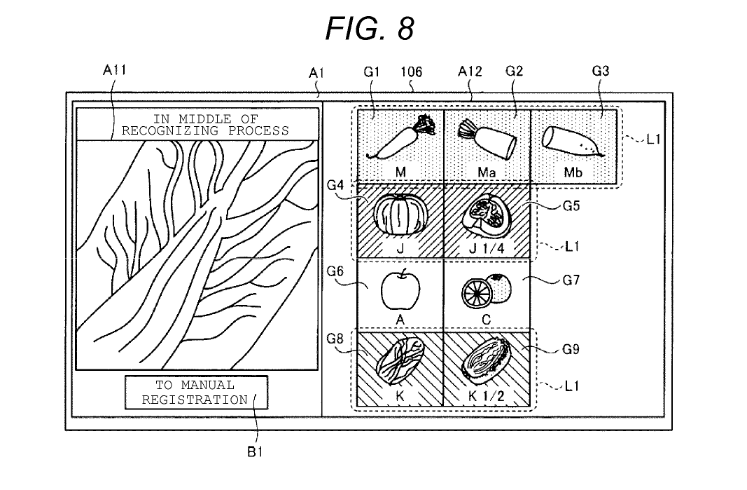

In addition, the arrangement layout is not limited to the fixed row and column arrangement which is illustrated in FIGS. 6 and 7, and may be an unfixed arrangement layout which is illustrated in FIG. 8. Here, FIG. 8 is a diagram which illustrates another display example of the candidate screen. In FIG. 8, it is possible to change the number of candidates which are arranged in each row. Here, candidates which belong to the same group are arranged side by side, and a display example in which the candidate is subjected to a color classification according to the group to which the candidate belongs is illustrated.

In this manner, since it is possible to display a candidate which has predetermined relevance as a group by arranging candidates for merchandise which belong to the same group side by side, it is possible to further improve a recognition property of a group of candidates for merchandise so that it becomes more useful.

In addition, examples in which a candidate which belongs to the same group is displayed by being highlighted so as to be recognized, by performing a color classification are illustrated in FIGS. 6 to 8; however, the method of the highlighting display is not limited to this. For example, as illustrated in FIGS. 6 to 8, a form of a highlighting display in which a candidate which belongs to the same group is recognizably displayed by being surrounded with an auxiliary line (frame) L1, or the like, may be used.

Returning to FIG. 5, the input reception unit 1616 receives various input operations corresponding to a display of the display unit 106 through the touch panel 105 or the keyboard 107. For example, the input reception unit 1616 receives a selection operation with respect to any one of the candidates which are displayed on the display unit 106. The input reception unit 1616 receives a selected candidate as merchandise (decided merchandise) corresponding to merchandise G which is captured by the image capturing unit 164. In addition, when the merchandise detection unit 1612 may detect plurality of merchandise G, the input reception unit 1616 may receive selection operations of a plurality of candidates.

The information output unit 1617 outputs information on merchandise (for example, merchandise ID, merchandise name, or the like) with respect to the decided merchandise to the POS terminal 11 through the connection interface 175.

In addition, the information output unit 1617 may output the number of merchandise to be sold which is separately input through the touch panel 105 or the keyboard 107 to the POS terminal 11 along with the merchandise ID, or the like. In addition, as information which is output to the POS terminal 11 by the information output unit 1617, the information output unit 1617 may directly notify of the merchandise ID which is read from the PLU file F1 by the information output unit 1617, may notify of a merchandise name of which a merchandise ID may be specified, or a file name of a merchandise image, or may notify of a storing location of the merchandise ID (storing address in PLU file F1).

The CPU 61 of the POS terminal 11 has a function as a sales registration unit 611 by executing a program. The sales registration unit 611 performs a sales registration of corresponding merchandise based on a merchandise ID and the number of merchandise to be sold which are output from the information output unit 1617 of the merchandise reading device 101. Specifically, the sales registration unit 611 refers to the PLU file F1, and performs the sales registration by recording the notified merchandise ID, and a merchandise classification, a merchandise name, a unit price, or the like, corresponding to the merchandise ID in a sales master file, or the like, along with the number of merchandise to be sold.

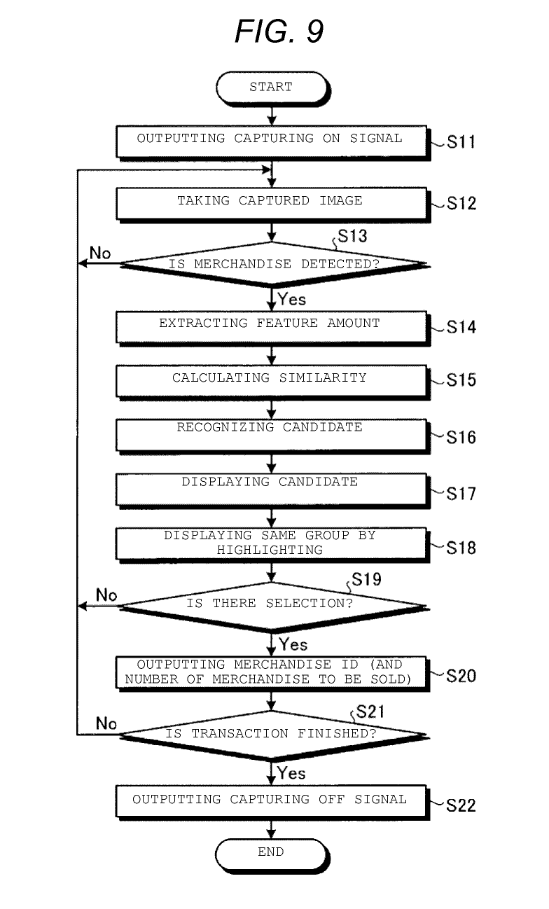

Hereinafter, operations of the checkout system 1 will be described. First, operations of the merchandise reading device 101 will be described with reference to FIG. 9. Here, FIG. 9 is a flowchart which illustrates a procedure of merchandise recognition processing which is executed by the merchandise reading device 101.

When the processing is started according to a start of a merchandise registration, or the like, using the POS terminal 11, the image taking unit 1611 starts the image capturing process using the image capturing unit 164 by outputting a capturing ON signal to the image capturing unit 164 (Step S11).

The image taking unit 1611 takes a frame image (captured image) which is captured using the image capturing unit 164, and is kept in the RAM 163 (Step S12). Subsequently, the merchandise detection unit 1612 detects all or a portion of merchandise G from the captured image which was taken in Step S12 (Step S13). Here, when the merchandise G is not detected (No in Step S13), the process returns to Step S12.

When the merchandise G is detected in Step S13 (Yes in Step S13), the feature data extracting unit 1613 extracts feature data of the merchandise G which is detected in Step S13 from the captured image taken in Step S12 (Step S14). Subsequently, the similarity determination unit 1614 compares the feature data which is extracted in Step S14 to feature data of each registered merchandise which is registered in the PLU file F1, and calculates similarity thereof, respectively (Step S15).

The similarity determination unit 1614 recognizes a merchandise ID of registered merchandise of which a value among the calculated similarities becomes equal to or greater than a predetermined threshold value as a candidate. In addition, the similarity determination unit 1614 specifies registered merchandise which belongs to the same group as that of the recognized candidate from the group setting file F2, and recognizes the registered merchandise as a candidate (Step S16).

The candidate presentation unit 1615 reads a record of the registered merchandise which is recognized as the candidate from the PLU file F1 of the POS terminal 11, and displays the record on the display unit 106 (Step S17). In addition, the merchandise candidate presentation unit 1615 displays a group of the candidate which belongs to the same group among the recognized candidates by highlighting the group in a distinguishable state (Step S18).

Subsequently, the input reception unit 1616 determines whether or not a selection of a candidate is received through the touch panel 105, or the keyboard 107 (Step S19). When the selection operation is performed (Yes in Step S19), the input reception unit 1616 sets the selected candidate as decided merchandise corresponding to the merchandise G, and the process proceeds to Step S20. In addition, when the selection of a candidate is not received in Step S19 (No in Step S19), the process returns to Step S12 again.

The information output unit 1617 outputs information on a merchandise ID of the decided merchandise, or the like, to the POS terminal 11 in Step S20 (Step S20), and the process proceeds to Step S21. Here, when the number of merchandise to be sold is separately input through the touch panel 105, or the keyboard 107, it is assumed that the number of merchandise to be sold is output to the POS terminal 11 along with the information denoting the decided merchandise in Step S20. In addition, when the input of the number of merchandise to be sold is not performed, the number of merchandise to be sold of “1” may be output as a default value.

In subsequent Step S21, the CPU 161 determines whether or not there is finishing of a business due to a completion notification, or the like, of a merchandise registration from the POS terminal 11 (Step S21). When the business is continued (No in Step S21), the CPU 161 causes the process to return to Step S12, and to continue processing. In addition, when the business is finished (Yes in Step S21), the image taking unit 1611 finishes capturing (Step S22) using the image capturing unit 164 by outputting a capturing OFF signal to the image capturing unit 164, and finishes the process.

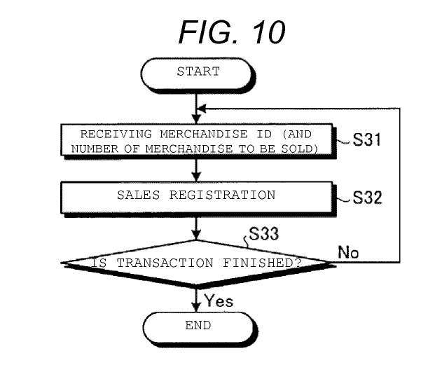

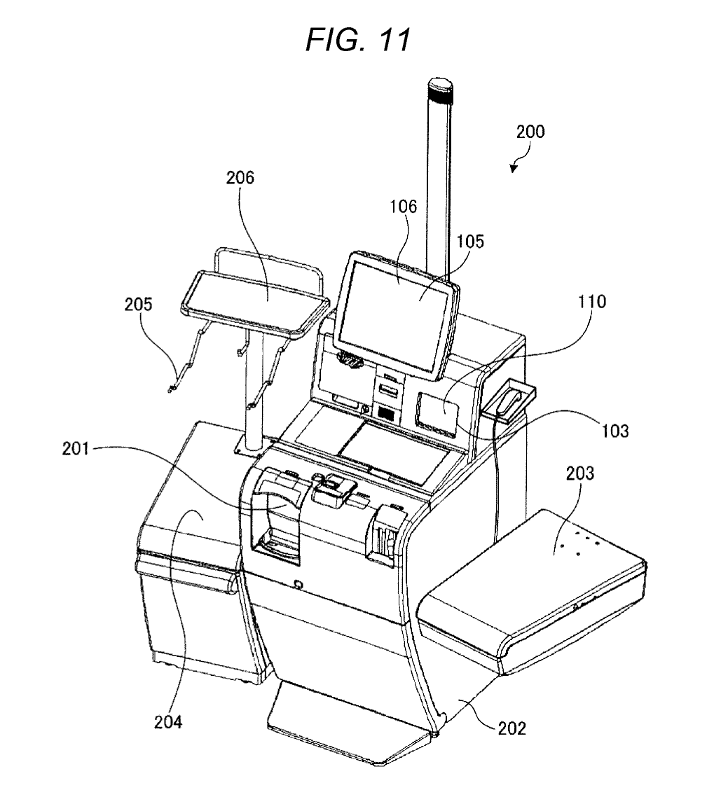

Subsequently, processing operations of the POS terminal 11 will be described. FIG. 10 is a flowchart which illustrates a procedure of a sales registering process which is executed by the POS terminal 11.

First, when processing is started according to a start of a merchandise registration, or the like, due to an operation instruction of the keyboard 22, the CPU 61 receives the merchandise ID of the decided merchandise, and the number of merchandise to be sold which are output in Step S20 in FIG. by the merchandise reading device 101 (Step S31). Subsequently, the sales registration unit 611 reads a type of merchandise, a unit price, or the like, from the PLU file F1 based on the received merchandise ID, and the number of merchandise to be sold which are received in Step S31, and registers the sales of the merchandise G which is read in the merchandise reading device 101 in the sales master file (Step S32).

Subsequently, the CPU 61 determines whether or not the sales transaction has completed, or the like, of a sales registration due to the operation instruction of the keyboard 22 (Step S33). When the sales transaction is to be continued (No in Step S33), the CPU 61 returns to Step S31, and causes the process to be continued. When the sales transaction has completed (Yes in Step S33), the CPU 61 finishes the process.

As described above, according to the embodiment, a group of candidates which has predetermined relevance, among those candidates that are recognized as the candidates of the merchandise G, is displayed by being highlighted in a distinguishable state. In this manner, since an operator may easily recognize a group of candidates for merchandise which has predetermined relevance, it is possible to improve usability of a display of candidates, or a selection of the candidates.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein maybe made without departing from the spirit of the inventions. The accompanying claims and their equivalents are intended to cover such forms or modifications as would fall within the scope and spirit of the inventions.

For example, the above described similarity determination unit 1614 has a form in which registered merchandise that belong to the same group is recognized together; however, the processing related to the recognition may not be performed. In such a case, the similarity determination unit 1614 sets only reference merchandise which is recognized using a comparison of feature data to a candidate. In addition, in the candidate presentation unit 1615, it is possible to exhibit the same effect as that of the above described embodiment, since highlighting of a candidate which belongs to the same group is performed.

In addition, according to the embodiment, a recognition of merchandise such as fruits and vegetables is described as an example; however, there is no limitation to a recognition target. For example, there maybe some configurations in which a plurality of foods which are placed on a tray are recognized as merchandise of an restaurant. In this case, for example, a plurality of menus which are set in advance as a set menu of a set meal A are caused to belong to a group. In addition, when there are a plurality of set menus, such as a set meal B and a set meal C in addition to the set meal A, each set menu is caused to belong to a group.

In addition, there may be some configurations in which, in a restaurant, merchandise for takeout which is a custom where a customer eats out of a store by taking out a food from the restaurant, or merchandise for eating in the restaurant is recognized. As a set menu of the merchandise for takeout, for example, there is a set menu which is configured of a hamburger, salad, potato, a soft drink, or the like, and a set menu which is configured of Gyudon, salad, or the like. In this case, for example, plurality of merchandise which is set in advance as an AA set is caused to belong to a group. In addition, when there are a plurality of set menus such as a BB set, and a CC set, each set menu is caused to belong to a group.

The similarity determination unit 1614 specifies registered merchandise which belongs to a group of merchandise which is set due to predetermined relevance with a recognized candidate from the group setting file F2, and recognizes the registered merchandise as a candidate. Accordingly, when the merchandise is recognized, and the recognized candidate belongs to the group which is set as the set menu, the merchandise which belongs to the same group is recognized as the candidate.

In addition, according to the embodiment, the POS terminal 11 includes the PLU file F1 and the group setting file F2; however, there may be variations to this, e.g., the merchandise reading device 101 may include a portion or all of the PLU file F1 and the group setting file F2.

In addition, according to the embodiment, identification of a candidate is performed in the merchandise reading device 101; however, the POS terminal 11 may include a portion or all of functional units of the merchandise reading device 101.

For example, the POS terminal 11 may include the feature data extracting unit 1613 and the similarity determination unit 1614, and the merchandise reading device 101 may include the image taking unit 1611, the merchandise detection unit 1612, the candidate presentation unit 1615, the input reception unit 1616, and the information output unit 1617. In this case, on the merchandise reading device 101 side, a captured image which is taken by the image taking unit 1611, and of which merchandise is detected in the merchandise detection unit 1612 is transmitted to the POS terminal 11. In addition, the merchandise reading device 101 has a configuration in which the merchandise (recognized on the POS terminal 11 side is received, and the candidate presentation unit 1615 presents the received merchandise as a candidate. In addition, when all of the functional units of the merchandise reading device 101 are included in the POS terminal 11, the merchandise reading device 101 functions as an image capturing device, and a display and selection of a candidate is performed in the POS terminal 11 based on the captured image which is transmitted from the merchandise reading device 101.

In addition, an example in which an installation type scanner (merchandise reading device 101) is used is described in the embodiment; however, there be variations to this, and a so-called handy type scanner may be connected to the POS terminal 11.

In addition, according the described embodiments, the merchandise reading device 101 is employed in the checkout system 1 which includes the POS terminal 11 and the merchandise reading device 101; however there may be variations to this, and a single device which includes the functions of the POS terminal 11 and the merchandise reading device 101, or, for example, a checkout system in which the merchandise reading device 101 and the POS terminal 11 which are illustrated in FIG. 1 are connected in a wired or wireless manner may be employed. As an example of the single device which includes functions of the POS terminal 11 and the merchandise reading device 101, there is a self checkout system which is provided and used in a store such as a supermarket.

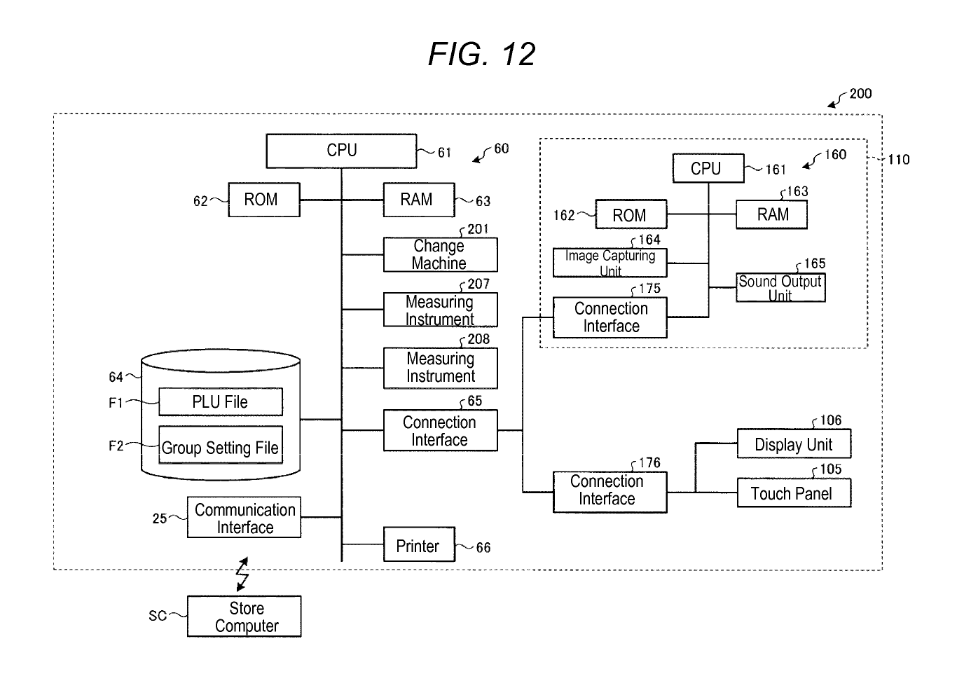

Here, FIG. 11 is a perspective view which illustrates an external configuration of a self checkout system 200, and FIG. 12 is a block diagram which illustrates a hardware configuration of the self checkout system 200. In addition, hereinafter, the same configurations as those in FIGS. 1 and 2 will be given the same reference numerals, and redundant descriptions thereof will be omitted.

As illustrated in FIGS. 11 and 12, a main body 202 of the self checkout system 200 includes a display unit 106 in which a touch panel 105 is arranged on the surface thereof, and a merchandise reading unit 110 which reads a merchandise image in order to recognize (detect) a type of merchandise, or the like.

As a display unit 106, for example, a liquid crystal display is used. The display unit 106 displays a guide screen for notifying a customer of an operation method of the self checkout system 200, various input screens, a registration screen for displaying merchandise information which is read in the merchandise reading unit 110, a settlement screen for displaying a total amount of merchandise, a deposit amount, a change amount, or the like, and selecting a payment method, or the like.

The merchandise reading unit 110 reads a merchandise image using the image capturing unit 164 when a customer holds up a code symbol which is attached to merchandise over a reading window 103 of the merchandise reading unit 110.

In addition, a merchandise mounting table 203 for placing unsettled merchandise in a basket is provided on the right side of the main body 202, and a merchandise mounting table 204 for placing settled merchandise is provided on the left side of the main body 202. In addition, a bag hook 205 which hooks a bag that holds settled merchandise, or a temporary placing table 206 for temporarily placing the settled merchandise before placing the merchandise into the bag is provided. The merchandise mounting tables 203 and 204 include measuring instruments 207 and 208, respectively, and have a function of confirming that a weight of merchandise is the same before and after the settlement.

In addition, a change machine 201 for performing receipt of paper money or paper money for change for settlement is provided in the main body 202 of the self checkout system 200.

When the exemplary embodiment is applied to the self checkout system 200 with such a configuration, the self checkout system 200 functions as an information processing device. In addition, the single device which is provided with the functions of the POS terminal 11 and the merchandise reading device 101 is not limited to the self checkout system 200 with the above described configuration, and may be a device with a configuration in which the measuring instruments 207 and 208 are excluded.

In addition, the program which is executed in each unit of the embodiment is provided by being incorporated in advance in a recording medium (ROM or storage unit) which is included in each unit; however, there may be other variations to this. For example, the program may be provided as a file with a format which may be installed or executed by being recorded in a non-transitory computer-readable recording medium such as a CD-ROM, a flexible disc (FD), a CD-R, and a Digital Versatile Disk (DVD). In addition, the recording medium is not limited to a medium independent from a computer or an embedded system, and a recording medium in which a program transmitted using a LAN, the Internet, or the like, is downloaded, and is stored or temporarily stored is also included.

In addition, there may be other configurations in which the program which is executed in each unit in the embodiment is stored in a computer which is connected to a network such as the Internet, and the programmed function is provided by being downloaded through the network. In addition, the program which is executed in each unit in the embodiment may be distributed through a network such as the Internet.

In addition, there may be other configurations in which the program in the embodiment is incorporated in a mobile information terminal such as a mobile phone with a communication function, a smart phone, a Personal Digital Assistant (PDA), and functions thereof are executed.

What is claimed is:

1. An information processing device comprising:
an image taking section having a connection to an image capturing device by which the image taking section instructs the image capturing device to capture an image of a merchandise;
a processor configured to recognize candidates based on the captured image of the merchandise; and
a display controller configured to display the candidates and highlight a group of the candidates that are related.

2. The device according to claim 1, further comprising:
a storage device that stores a data structure in which a group of related merchandise is set.

3. The device according to claim 1,
wherein the display controller is configured to highlight by performing a color classification of the related candidates.

4. The device according to claim 1,
wherein the display controller is configured to highlight by surrounding the related candidates with a frame.

5. The device according to claim 1, wherein the processor is configured to recognize candidates based on a similarity level between the captured image of the merchandise and previously captured images of merchandise.

6. The device according to claim 5, wherein the similarity level of each of the candidates is above a threshold level.

7. The device according to claim 6,
wherein the candidates include a first group of related candidates that are displayed in a first color, a second group of related candidates that are displayed in a second color, and a third group of unrelated candidates that are displayed in a third color.

8. The device according to claim 5,
wherein the processor is further configured to compare feature data of the captured image of the merchandise and feature data of previously captured images of merchandise to determine a similarity level.

9. An information processing method comprising:
capturing an image of a merchandise;
computing a similarity level between the captured image of the merchandise and previously captured images of merchandise;
recognizing candidates based on the computed similarity levels; and
displaying the candidates and highlighting a group of the candidates that are related.

10. The method according to claim 9, wherein the highlighting includes displaying the related candidates in a different color than the other candidates.

11. The method according to claim 9, wherein the highlighting includes surrounding the related candidates with a frame.

12. The method according to claim 9, wherein the similarity level between the captured image of the merchandise and each of the candidates is above a threshold level.

13. The method according to claim 12,
wherein the candidates include a first group of related candidates that are displayed in a first color, a second group of related candidates that are displayed in a second color, and a third group of unrelated candidates that are displayed in a third color.

14. The method according to claim 9, wherein said computing the similarity level includes
comparing feature data of the captured image of the merchandise and feature data of previously captured images of merchandise to determine a similarity level.

15. A non-transitory computer readable medium comprising instructions for causing an information processing device to perform the steps of:
capturing an image of a merchandise;
computing a similarity level between the captured image of the merchandise and previously captured images of merchandise;
recognizing candidates based on the computed similarity levels; and
displaying the candidates and highlighting a group of the candidates that are related.

16. The non-transitory computer readable medium according to claim 15, wherein the highlighting includes displaying the related candidates in a different color than the other candidates.

17. The non-transitory computer readable medium according to claim 15, wherein the highlighting includes surrounding the related candidates with a frame.

18. The non-transitory computer readable medium according to claim 15, wherein the similarity level between the captured image of the merchandise and each of the candidates is above a threshold level.

19. The non-transitory computer readable medium according to claim 18,
wherein the candidates include a first group of related candidates that are displayed in a first color, a second group of related candidates that are displayed in a second color, and a third group of unrelated candidates that are displayed in a third color.

20. The non-transitory computer readable medium according to claim 15, wherein said computing the similarity level includes
comparing feature data of the captured image of the merchandise and feature data of previously captured images of merchandise to determine a similarity level.
